(19) United States
(12) Patent Application Publication
(10) Pub. No.: US 2025/0148384 A1
(43) Pub. Date: May 8, 2025

(54) ANALYZING USER ACTIVITY DATA TO GENERATE ACTIVITY INFORMATION FOR USE BY GENERATIVE ARTIFICIAL INTELLIGENCE (AI) TO GENERATE REPORTS

(71) Applicant: INTERNATIONAL BUSINESS MACHINES CORPORATION, Armonk, NY (US)

(72) Inventors: Peng Hui Jiang, Beijing (CN); Su Liu, Austin, TX (US); Guang Han Sui, Beijing (CN); Shunguo Yan, Austin, TX (US)

(21) Appl. No.: 18/504,728

(22) Filed: Nov. 8, 2023

(51) Int. Cl. G06Q 10/0631; G06F 40/40; G06Q 10/0639; G06Q 10/1091

(52) U.S. Cl. CPC G06Q 10/063114; G06F 40/40; G06Q 10/06393; G06Q 10/1091

(57) ABSTRACT

Provided are a computer program product, system, and method for analyzing user activity data to generate activity information for use by generative artificial intelligence (AI) to generate reports. Activity data includes information on an activity in which a monitored user engages, including a time period during which the monitored user was engaged in the activity and a description of the activity. An activity categorizer comprising a machine learning model classifier processes the time period and the description of the activity; to output an activity category. A status report generator generates a status report for the activity category, including the activity category of the activity and key attributes of the activity category including the time spent on the activity category and information on the activity. The status report is updated to a database.

### BACKGROUND OF THE INVENTION

### 1. Field of the Invention

The present invention relates to a computer program product, system, and method for analyzing user activity data to generate activity information for use by generative artificial intelligence (AI) to generate reports.

### 2. Description of the Related Art

Generative Artificial Intelligence (AI) uses large language models and natural language processing to generate content. Businesses utilize generative AI to automate content creation, such as produce business reports and create personalized product recommendations. Generative AI systems utilize machine learning and are trained on business data sets to produce reports, such as business reports and executive summaries, based on business data. Generative AI deployed to generate business reports can substantially improve productivity by automatically and instantly generating detailed business reports based on business data in a format suitable for the organization.

### SUMMARY

Provided are a computer program product, system, and method for analyzing user activity data to generate activity information for use by generative artificial intelligence (AI) to generate reports. Activity data includes information on an activity in which a monitored user engages, including a time period during which the monitored user was engaged in the activity and a description of the activity. An activity categorizer comprising a machine learning model classifier processes the time period and the description of the activity; to output an activity category. A status report generator generates a status report for the activity category, including the activity category of the activity and key attributes of the activity category including the time spent on the activity category and information on the activity. The status report is updated to a database.

### BRIEF DESCRIPTION OF THE DRAWINGS

FIG. 1 illustrates an embodiment of a computing environment to analyze user activities and generate reports on user activity.

FIG. 2 illustrates an embodiment of an activity information instance for a user activity.

FIGS. 3A and 3B illustrate an example of a table of activity information instances.

FIG. 4 illustrates an embodiment of operations to monitor an activity in a user computer to capture activity data for a user.

FIG. 5 illustrates an embodiment of operations to monitor an activity in an Internet of Things sensor to capture activity data for a user.

FIG. 6 illustrates an embodiment of operations to generate activity information from received user activity data.

FIG. 7 illustrates an embodiment of operations to generate status reports for activity categories for a user and for a time period.

FIG. 8 illustrates an embodiment of operations to generate a general status report

for activity categories from generated status reports.

FIG. 9 illustrates an example of a general status report generated from status reports for activity categories for a user and for a time period.

FIG. 10 illustrates a computing environment in which the components of FIG. 1 may be implemented.

### DETAILED DESCRIPTION

Described embodiments provide improvements to computer technology for using generative artificial intelligence (AI), such as generative adversarial networks (GANs), to generate status reports on user activities. Described embodiments provide improved computer technology to process collected user activity data to identify key attributes of the user activity and then use the key attributes along with other information to input to machine learning model classifiers to determine further derivate information on the user activity, such as a user role during activity and an activity category. Described embodiments provide further techniques to consolidate the activity information that is generated, and then provide the consolidated activity information, along with information derived from the machine learning model classifiers, as input to a report generator comprising generative AI to generate status reports. Described embodiments improve the output from the generative AI by providing to the generative AI derivative information produced by machine learning classifiers that improve the output.

Described embodiments provide improvements to computer technology to effectively track and manage user activity. Current status reporting methods are often time consuming, prone to inaccuracies, and lack the ability to provide customized reports for each role. Manually creating and uploading different status reports for each manager and project can be burdensome, leading to potential overlaps in content and varying levels of detail. Described embodiments address these problems by gathering information on user activity from the Internet of Things (IoT) and human computer interaction to monitor a user's activities across different projects and tasks. The described embodiments provide further improvements to computer technology to categorize the different tracked activities, summarize activity, and generate various status reports on activities.

Though this disclosure pertains to the collection of data (e.g., user activity across different projects and tasks) it is noted that in embodiments, users opt into the system. In doing so, they are informed of what data is collected and how it will be used, that any collected personal data may be encrypted while being used, that the users can opt-out at any time, and that if they opt out, any personal data of the user is deleted.

FIG. 1 illustrates an embodiment of an activity analysis server 100 in communication over a network 102 with user computers 104 and Internet of Things sensors 106. The user computers 104 and internet of things sensors 106 include activity monitors 108, 110, respectively, that gather activity data for users detected by the activity monitors 108, 110 to transmit to the activity analysis server 100 to process and generate reports. The activity analysis server 100 includes an activity bot 112 to analyze user activity data 114 received from the activity monitors 108. 110. The user activity data 114 may indicate a user, time and location of activity, other participants involved in activity, engagement level, such as units of work completed, project status, applications in which activity occurred, eye-gazed points, computer input, communication logs in multiple channels and formats, meeting participant data, etc. The user activity data 114 may further include a word cloud of content the user enters in applications during the activity.

A key attribute identifier 116 processes the user activity data 114 to generate key attributes 118 of the activity, such as information on a user, time and location of activity, other participants involved in activity, engagement level (e.g., hours spent and units of work, such as completed lines of code, number of projects or tasks completed) project status of activity, etc.

A user profile database 120 includes information for each user including a role list 122 indicating roles in an organization in which a user operates, user activity categories 124 indicating activity categories in which the user participates, and user report templates 126 including a format, layout, and guidance of a preferred report structure for the user.

The role list 122 along with the key attributes 118 are inputted to a role categorizer 128, such as a machine learning model classifier, to output a user role 130 in which the user acted when engaged in the activity recorded in the received user activity data 114. The user role 130, the user activity categories 124, and the key attributes 118 are inputted to an activity categorizer 132, such as a machine learning model classifier, to output an activity category 134 for the activity.

The activity bot 112 may generate activity information 200 that includes the key attributes 118, user role 130, and activity category 134. Multiple instances of activity information 200 for a user for a measurement time period may be inputted into an activity summarizer 136 to consolidate multiple instances of activity information 200 for one activity category for the time period into a consolidated activity information instance 200c. Consolidated activity information 200c or a, single, non-consolidated single activity information instance 200; is inputted to a status report generator 140 to output a status report 142 in a readable and printable format. The status report generator 140, may implement generative artificial intelligence, such as a generative adversarial network (GAN). A report uploader 144 may upload the status report 142 to a report database 146, which may include separate activity category databases to which status reports for a particular activity category is uploaded. Alternatively, status reports 142 for all activity categories may be stored in a same database and distinguished by their activity category indicated in the database records.

A general report generator 148 may access status reports 142 from the report database 146, for a user for a time period and for different activity categories, and a user report template 126 and generate a general report 150 across activities for the user following the structure and format of the user report template 126.

An activity report learner 152, which may comprise a machine learning model classifier, may process status reports in the report database 146 to output additional roles of the user to include in the role list 122 and additional activity categories in which the user participated to include the user activity categories 124 to update and maintain current the user role list 122 and activity categories 124.

The network 102 may comprise a network such as a Storage Area Network (SAN), Local Area Network (LAN), Intranet, the Internet, Wide Area Network (WAN), peer-to-peer network, wireless network, arbitrated loop network, etc.

The arrows shown in FIG. 1 between the components and objects in the activity bot 112 represent a data flow between the components.

Generally, program modules, such as the program components 108, 110, 112, 116, 128, 132, 136, 140, 144, 148, and 152, among others, may comprise routines, programs, objects, components, logic, data structures, and so on that perform particular tasks or implement particular abstract data types. The program components and hardware devices of the systems 100, 104, 106 may be implemented in one or more computer systems, where if they are implemented in multiple computer systems, then the computer systems may communicate over a network.

The program components 108. 110, 112, 116, 128, 132, 136, 140, 144, 148, and 152, among others, may be accessed by a processor from memory to execute. Alternatively, some or all of the program components 108, 110, 112, 116, 128, 132, 136, 140, 144, 148, and 152, among others, may be implemented in separate hardware devices, such as Application Specific Integrated Circuit (ASIC) hardware devices. Program components implemented as machine learning models, such as program components 128, 132, 140, 148, among others, may be implemented in an Artificial Intelligence (AI) hardware accelerator.

In certain embodiments, program components 128, 132, 140, 148, among others, may use machine learning and deep learning algorithms, such as decision tree learning, association rule learning, neural network, inductive programming logic, support vector machines, Bayesian network, Recurrent Neural Networks (RNN), Feedforward Neural Networks, Convolutional Neural Networks (CNN), Deep Convolutional Neural Networks (DCNNs), Generative Adversarial Network (GAN), etc. For artificial neural network program implementations, the neural network may be trained using backward propagation to adjust weights and biases at nodes in a hidden layer to produce their output based on the received inputs which may comprise the inputs received during operations by the machine learning models 128, 132, 140, 148. In backward propagation used to train a neural network machine learning module, biases at nodes in the hidden layer are adjusted accordingly to produce the desired output based on the received inputs which may comprise the inputs received during operations by the machine learning models 128, 132, 140, 148.

In an alternative embodiment, the components 128, 132, 140, 148 may be implemented not as a machine learning module, but implemented using a rules based system to determine the outputs from the inputs. The components 128, 132, 140, 148 may further be implemented using an unsupervised machine learning module, or machine learning implemented in methods other than neural networks, such as multivariable linear regression models.

In certain embodiments, role categorizer 128 and the activity categorizer 132 may comprise classifier machine learning models to classify input into a category, such as a user role 130 and activity category 134, respectively. The status report generator 140 and general report generator 148 may comprise generative adversarial networks (GAN).

The functions described as performed by the program components 116, 122, 126, 138, 142, among others, may be implemented as program code in fewer program modules than shown or implemented as program code throughout a greater number of program modules than shown.

The user computer 104 may comprise a personal computing device, such as a laptop, desktop computer, tablet, smartphone, wearable computer, augmented reality glasses, etc. The activity analysis server 100 may comprise one or more server class computing devices, or other suitable computing devices.

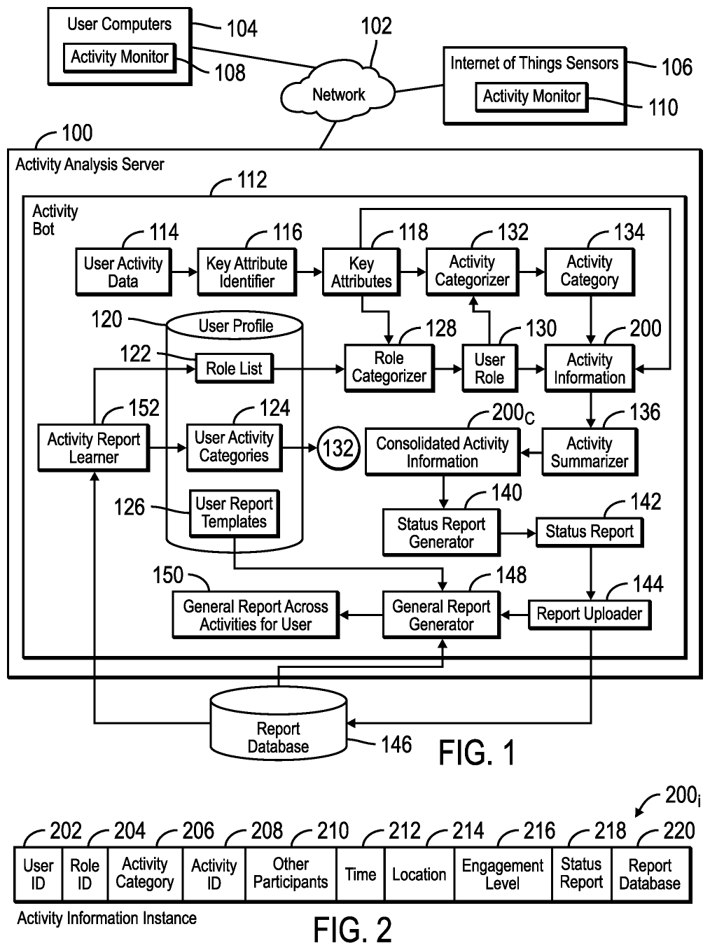

FIG. 2 illustrates an embodiment of an instance of activity information 200i generated for a user and activity recorded in the received user activity data 114 participant, and includes: a user identifier (ID) 202 of a user for which the data 114 was gathered; a role ID 204 of the user when engaged in the activity, as determined by the role categorizer 128; an activity category 206 determined by the activity categorizer 132 processing the user activity data 114; an activity ID 208 providing an identifier of the activity recorded in the user activity data 114 instance for which the analysis information 200; is generated; other participants 210 involved in the activity; a time 212 and location 214 the activity occurred; an engagement level 216 of the user 202 in the activity 208, such as time spent, work units generated during the activity, such as lines of computer code created, documents created, projects and tasks completed, etc.; a status report 218, comprising status report 142, generated by the status report generator 140 the generated information; and a report database 220 in which the status report 218 generated for the activity 208 is stored, such as in report database 146.

The activity information 200; may include other gathered information from the user activity data 114, including projects for which activity performed, tasks completed, status of projects for which activity performed, etc.

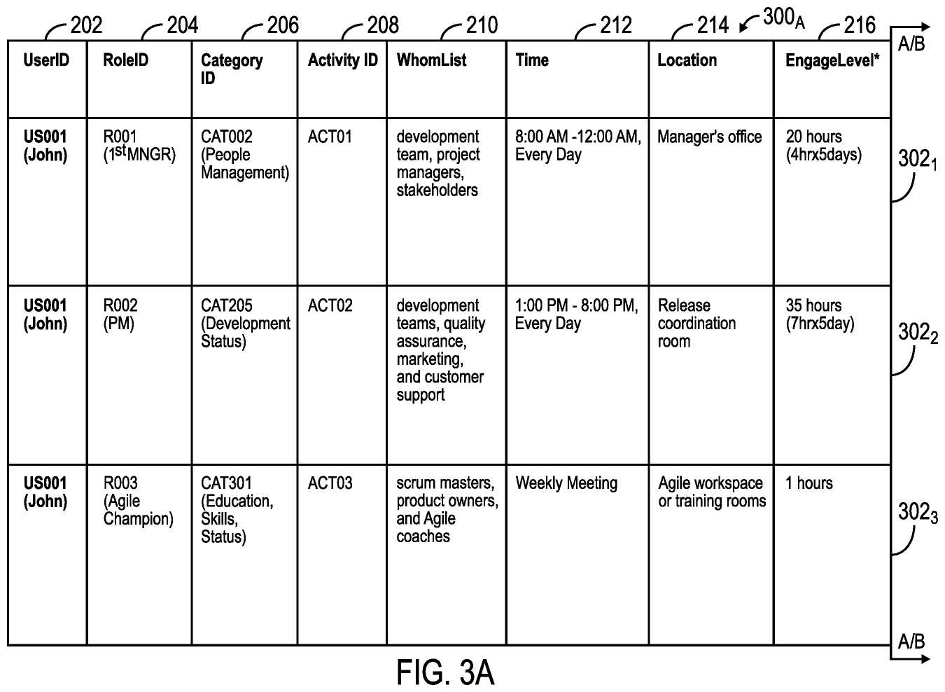

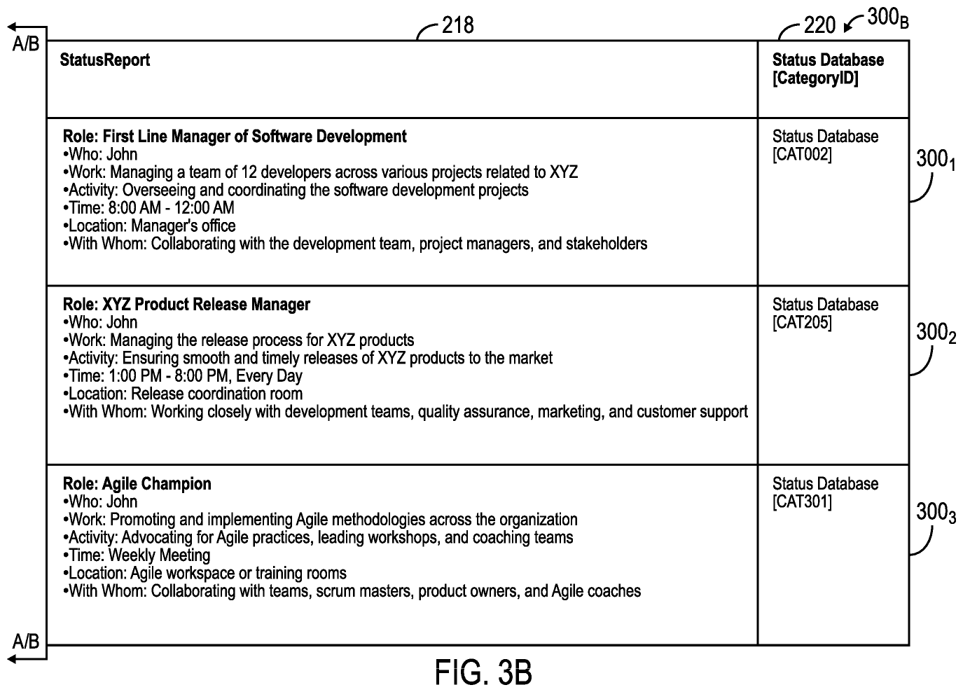

FIGS. 3A and 3B illustrate columns 300A and 300B of a table where each row 302₁, 302₂, 302₃ comprises an instance of activity information 200; generated from three instances of activity data 114 received for a user named “John” with user ID US001. The columns of the table 300A, 300B correspond to the fields of participant interaction information 200i, shown in FIG. 2, and are labeled with the corresponding fields from the participant interaction information 200; used in FIG. 2.

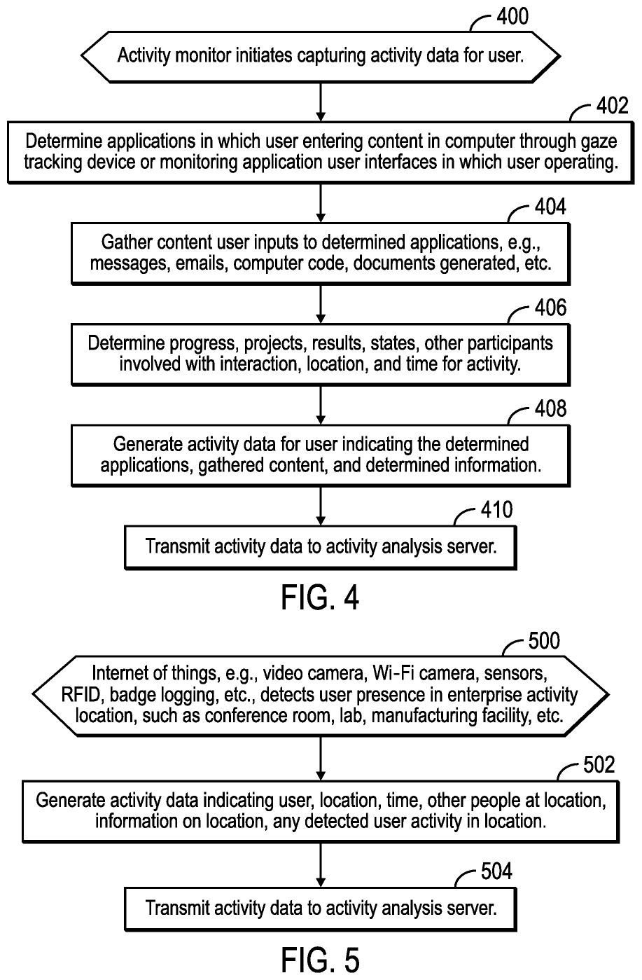

FIG. 4 illustrates an embodiment of operations performed by the activity monitor 108 in the user computer 104 to capture activity information at the user computer 104. Upon the activity monitor 108 initiating (at block 400) activity information capture, the activity monitor 108 determines (at block 402) applications in which user is entering content in the computer 104 through a gaze tracking device, e.g., video camera or gaze tracking glasses, or monitoring application user interfaces in which the user is operating. The activity monitor 108 gathers (at block 404) content the user inputs to the determined applications, e.g., messages, emails, computer code, documents generated, etc. The activity monitor 108 may further determine (at block 406) progress, projects, results, states, other participants involved with interaction, location, and time for activity. Activity data 114 is generated (at block 408) for the user indicating the determined applications, gathered content, and determined information and transmitted (at block 410) to the activity analysis server 100.

FIG. 5 illustrates an embodiment of operations performed by the activity monitor 110 to capture activity information from an Internet of Things sensor 106. An internet of things sensor 106, such as a video camera, Wi-Fi camera, sensors, RFID, badge logging, etc., detects (at block 500) user presence in an enterprise activity location, such as conference room, lab, manufacturing facility, etc. The activity monitor 110 generates (at block 502) activity data 114 indicating user, location, time, other people at location, information on location, any detected user activity at in location and transmits (at block 504) the activity data 114 to the activity analysis server 100 for further processing.

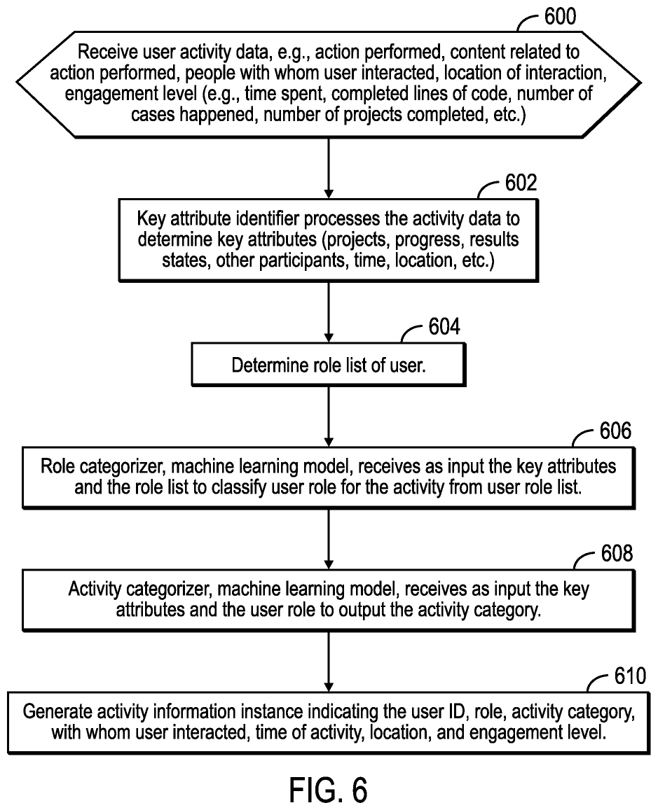

FIG. 6 illustrates an embodiment of operations performed by the activity bot 112 and components therein to process received user activity data 114 to generate activity information instance 200; for the received user activity data 114 that may be later processed to generated status reports 142 for the recognized activity categories and a general report 150 across activities. The activity bot 112 receives (at block 600) user activity data 114, indicating action performed, applications interacted with, meetings attended, content entered related to action performed, people with whom user interacted, location of interaction, engagement level (e.g., time spent, completed lines of code, number of cases happened, number of projects completed, etc.). The key attribute identifier 116 processes (at block 602) the user activity data 114 to determine key attributes 118, such as projects, progress, results states, other participants, time, location, etc. A role list 122 of roles for the user is determined (at block 604) from the user profile 120. The role categorizer 128 receives (at block 606) as input the key attributes 118 and the role list 122 to determine a classification of the user role 130 for the activity from user role list 122. The activity categorizer 132 receives (at block 608) as input the key attributes 118 and user role 130 to output the activity category 134 classifying the activity recorded in the user activity data 114. The activity bot 112 may generate (at block 610) activity information instance 200; indicating the user ID 202, role 204, activity category 206, with whom user interacted 210, time of activity 212, location 214, engagement level 216 and any other activity information extracted from the user activity data 114.

With the embodiment of FIG. 6, information from user activity data 114 may be extracted to store in activity information 200j, and information may be derived from the received user activity data 114 using machine learning model classifiers, such as the role categorizer 128 to determine a user role 130 and the activity categorizer 132 to determine the activity category 134. This provides improved computer technology for extracting and deriving information on user activity data that may be used to generate reports on the user activity to optimize enterprise operations.

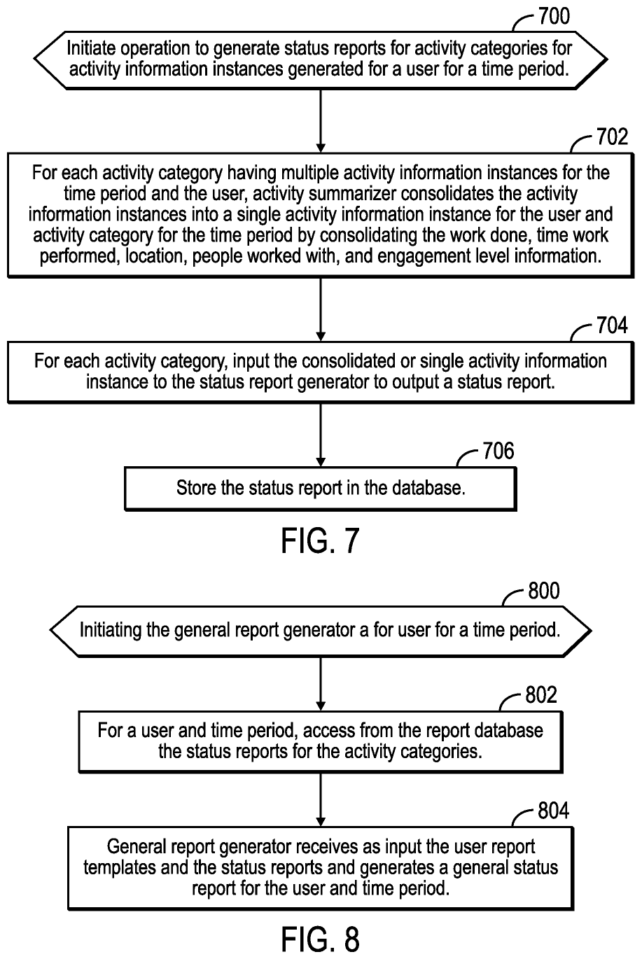

FIG. 7 illustrates an embodiment of operations performed the activity bot 112 and components to generate status reports 142 for activity categories for activity information instances generated 200ᵢ for a user for a time period. Upon initiating (at block 700) the generating of status reports 142, for each activity category having multiple activity information instances 200ᵢ for the time period and the user, the activity summarizer 136 consolidates (at block 702) the multiple activity information instances 200ᵢ into a single activity information instance for the user and activity category for the time period by consolidating the work done, time work performed, location, people worked with, and engagement level information. For each activity category, the activity bot 112 inputs (at block 704) the consolidated 200c or single 200ᵢ activity information instance to the status report generator 140 to output a status report 142 for each activity category. The status report 142 is stored (at block 706) in the report database 146.

FIG. 8 illustrates an embodiment of operations performed by the activity bot 112 and general report generator 148 to generate a general report 150 for a user across activities performed. Upon initiating (at block 800) the general report generator 148 for a user and for a time period, the activity bot 112 accesses (at block 802) the status reports 142 for a user, activity categories, and a time period. The general report generator 148 receives (at block 804) as input the accessed status reports 142 and user report template 126 and generates a general status report 150 for the user and time period for all activity categories.

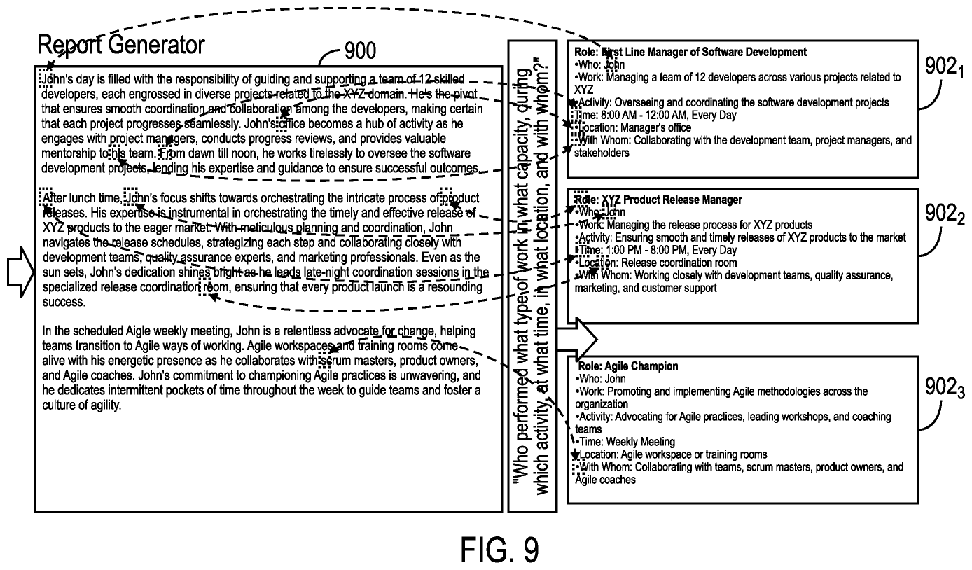

FIG. 9 illustrates an example of how a general status report 900, such as general status report 150, is generated from accessed status reports 902₁, 902₂, 902₃ for a user for a time period. As can be seen, the general status report 900 provides a discussion of the more brief 902₁, 902₂, 902₃ status reports in paragraph form with a narrative description of what the user did as part of the activities for the time period. FIG. 9 further shows how information in the status reports 902₁, 902₂, 902₃ maps to the general report 900.

The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

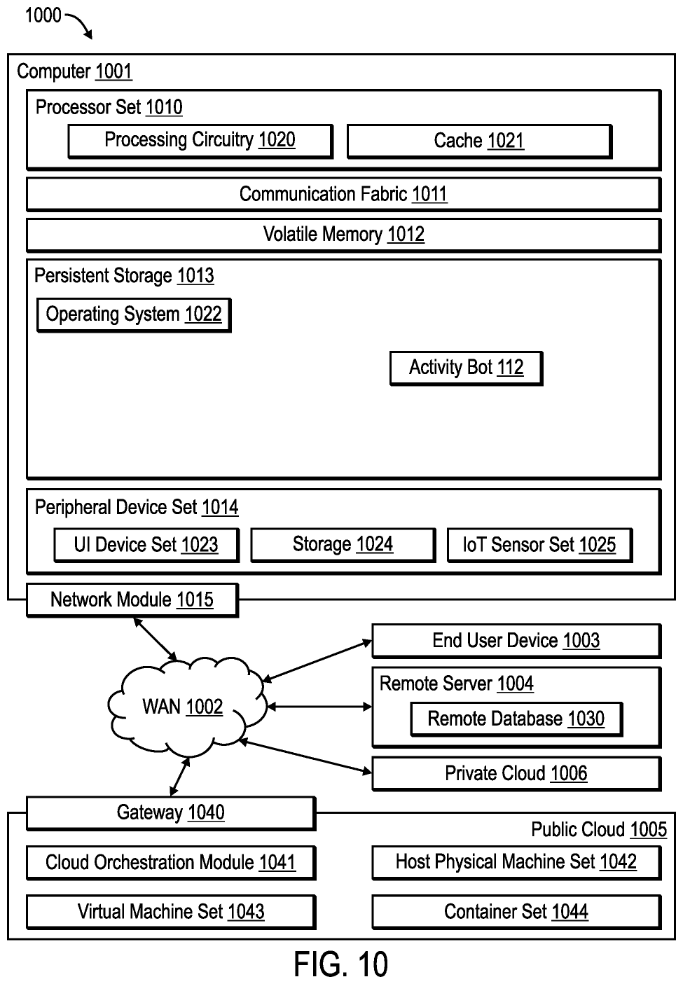

With respect to FIG. 10, computing environment 1000 contains an example of an environment for the execution of at least some of the computer code involved in performing the inventive methods performed by the activity bot 112, and components therein, as described above with respect to FIG. 1, to generate activity information and generate status reports. In addition to the activity bot 112, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and activity bot 112, as identified above), peripheral device set 1014 (including user interface (UI) device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be implemented in the activity bot 112 in persistent storage 1013.

COMMUNICATION FABRIC 1011 is the signal conduction path that allows the various components of computer 1001 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, volatile memory 1012 is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface-type operating systems that employ a kernel. The code included in the activity bot 112 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN 1002 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on. The EUD 1004 may comprise the user computers 104 and Internet of Things sensors 106 described above with respect to FIG. 1.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004. The remote database 1030 may comprise the user profile 120 and report database 146.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002. Some further explanation of virtualized computing environments (VCEs) will

now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

The letter designators, such as i and n, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product for processing information on user activity to categorize and generate output, the computer program product comprising a computer readable storage medium having computer readable program code embodied therein that is executable to perform operations, the operations comprising:
receiving activity data having information on an activity in which a monitored user engages, including a time period during which the monitored user was engaged in the activity and a description of the activity.
processing, by an activity categorizer comprising a machine learning model classifier, the time period and the description of the activity; to output an activity category;
generating, by a status report generator, a status report for the activity category, including the activity category of the activity and key attributes of the activity category including the time period on the activity category and information on the activity; and
uploading the status report to a database.

2. The computer program product of claim 1, wherein the operations further comprise:
inputting status reports for activity categories for a time period to a report generator, implementing generative artificial intelligence, to generate a general report across activities including information on the activity categories in which the monitored user was engaged for the time period from the status reports.

3. The computer program product of claim 1, wherein the operations further comprise:
generating an activity information instance for each received activity data instance for the monitored user for a time period, wherein an activity information instance includes the activity category, the time period, information on the activity and other users involved in the activity, inputted to the activity categorizer to generate the activity category; and
consolidating multiple activity information instances generated from activity data received for the time period and having a same activity category into a consolidated activity information instance, wherein the status report generator generators the status report for the activity category for the time period from the consolidated activity information instance.

4. The computer program product of claim 1, wherein the information on the activity comprises content the monitored user entered into an application program during the time period.

5. The computer program product of claim 4, wherein the content comprises a word cloud generated from communications with another user during the time period.

6. The computer program product of claim 1, wherein the information on the activity indicates units of work completed during the activity.

7. The computer program product of claim 1, wherein the operations further comprise:
retrieving status reports generated for a user for a time period for activity categories; and
inputting the retrieved status reports to a general status report generator implementing generative artificial intelligence to generate a report describing user activity for the activity categories during the time periods.

8. The computer program product of claim 1, wherein the operations further comprise:
inputting the information on the activity and a role list of user roles to a role categorizer, implementing a classifier machine learning model, to output a role comprising one of the roles in the role list for the monitored user, wherein the output role is additionally inputted to the activity categorizer to output the activity category.

9. The computer program product of claim 1, wherein the operations further comprise:
generating an activity information instance for each received activity data including the monitored user, a role of the monitored user associated with the activity data, the activity category based on the activity data, another user involved in the activity, a duration of the activity represented in the activity data, wherein the status report generator generates the status report from the activity information instance.

10. A system for processing information on user activity to categorize and generate output, comprising:
a processor; and
a computer readable storage medium having computer readable program code embodied therein that is executable to perform operations, the operations comprising:
receiving activity data having information on an activity in which a monitored user engages, including a time period during which the monitored user was engaged in the activity and a description of the activity.
processing, by an activity categorizer comprising a machine learning model classifier, the time period and the description of the activity; to output an activity category;
generating, by a status report generator, a status report for the activity category, including the activity category of the activity and key attributes of the activity category including the time period and information on the activity; and
uploading the status report to a database.

11. The system of claim 10, wherein the operations further comprise:
inputting status reports for activity categories for a time period to a report generator, implementing generative artificial intelligence, to generate a general report across activities including information on the activity categories in which the monitored user was engaged for the time period from the status reports.

12. The system of claim 10, wherein the operations further comprise:
generating an activity information instance for each received activity data instance for the monitored user for a time period, wherein an activity information instance includes the activity category, the time period, information on the activity and other users involved in the activity, inputted to the activity categorizer to generate the activity category; and
consolidating multiple activity information instances generated from activity data received for the time period and having a same activity category into a consolidated activity information instance, wherein the status report generator generators the status report for the activity category for the time period from the consolidated activity information instance.

13. The system of claim 10, wherein the information on the activity indicates units of work completed during the activity.

14. The system of claim 10, wherein the operations further comprise:
retrieving status reports generated for a user for a time period for activity categories; and
inputting the retrieved status reports to a general status report generator implementing generative artificial intelligence to generate a report describing user activity for the activity categories during the time periods.

15. The system of claim 10, wherein the operations further comprise:
inputting the information on the activity and a role list of user roles to a role categorizer, implementing a classifier machine learning model, to output a role comprising one of the roles in the role list for the monitored user, wherein the output role is additionally inputted to the activity categorizer to output the activity category.

16. A method for processing information on user activity to categorize and generate output, comprising:
receiving activity data having information on an activity in which a monitored user engages, including a time period during which the monitored user was engaged in the activity and a description of the activity.
processing, by an activity categorizer comprising a machine learning model classifier, the time period and the description of the activity; to output an activity category;
generating, by a status report generator, a status report for the activity category, including the activity category of the activity and key attributes of the activity category including the time period and information on the activity; and
uploading the status report to a database.

17. The method of claim 16, further comprising:
inputting status reports for activity categories for a time period to a report generator, implementing generative artificial intelligence, to generate a general report across activities including information on the activity categories in which the monitored user was engaged for the time period from the status reports.

18. The method of claim 16, further comprising:
generating an activity information instance for each received activity data instance for the monitored user for a time period, wherein an activity information instance includes the activity category, the time period, information on the activity and other users involved in the activity, inputted to the activity categorizer to generate the activity category; and
consolidating multiple activity information instances generated from activity data received for the time period and having a same activity category into a consolidated activity information instance, wherein the status report generator generators the status report for the activity category for the time period from the consolidated activity information instance.

19. The method of claim 16, further comprising:
retrieving status reports generated for a user for a time period for activity categories; and
inputting the retrieved status reports to a general status report generator implementing generative artificial intelligence to generate a report describing user activity for the activity categories during the time periods.

20. The method of claim 16, further comprising:
inputting the information on the activity and a role list of user roles to a role categorizer, implementing a classifier machine learning model, to output a role comprising one of the roles in the role list for the monitored user, wherein the output role is additionally inputted to the activity categorizer to output the activity category.
